(19) United States
(12) Patent Application Publication
(10) Pub. No.: US 2014/0367624 A1
(43) Pub. Date: Dec. 18, 2014

(54) RETRACTABLE FRAME FOR A MAINTENANCE VEHICLE

(71) Applicant: AZTEC, Chavanod (FR)

(72) Inventors: Xavier Jean, Saint Offenge Dessous (FR); Frederic Cuilliere, Saint Martin Bellevue (FR)

(73) Assignee: AZTEC, Chavanod (FR)

(21) Appl. No.: 14/351,324

(22) PCT Filed: Oct. 12, 2012
(86) PCT No.: PCT/EP2012/070292

§ 371 Date: Apr. 11, 2014

(30) Foreign Application Priority Data
Oct. 13, 2011 (FR) FR1103133

(51) Int. Cl. B66D 1/28; B66D 1/60; B66D 1/36

(52) U.S. Cl. CPC B66D 1/28; B66D 1/36; B66D 1/60
USPC 254/323

(57) ABSTRACT

The present invention relates to a frame (1) which is to be mounted onto a ski slope maintenance vehicle (15) having a winch (17), and which supports a jib (3) for directing a cable (21) between a reeling drum (23) of the winch (17) and a point for attaching the cable (21) for pulling the vehicle (15), wherein said frame (1) includes a deformable quadrilateral structure (5) that makes it possible to vary the height of the jib (3).

The present invention relates to the field of ski run maintenance vehicles and more particularly vehicles equipped with, a winch by means of which a cable can be used to compensate for the traction torque.

This type of vehicle is already widely used throughout the world and allows a significant increase in the range of action of maintenance vehicles by allowing access to steeper areas and/or areas in which the snowpack is not very stable.

Moreover, in order to be able to orient the cable between the winch and the attachment point, the vehicles are equipped with a jib which is situated above the level of the cabin and can be turned through 360°. However, these jibs increase the overall height of the vehicle which can be a problem for storage of the vehicles, bringing them into a workshop fir maintenance or in the event of a raised obstacle on a ski run, for example a chairlift.

In the prior art, one solution for limiting the height of the vehicle consists in “laying” the jib on its side by means of a manual pump located level with the jib. However, this solution requires the driver of the vehicle to carry out a manipulation outside the cabin which can be dangerous and is time-consuming and is therefore carried out only in the event of the vehicle being put into storage. Moreover; this solution can be implemented only when the cable is not “loaded”, which also prevents it from being used on-site.

It is therefore the object of the present invention to overcome, at least partially, the abovementioned drawbacks of the prior art and to propose a system by means of which the height of the jib can be adjusted simply and when it is in Use on-site.

The present invention therefore relates to a frame designed to be mounted on a ski run maintenance vehicle having a winch and supporting a jib designed to orient as cable between a winding drum of the winch and an attachment point of the traction cable of the vehicle, wherein said frame comprises a deformable quadrilateral structure by means of which the height of the jib can be varied.

According to another aspect of the present invention, the deformable quadrilateral structure comprises an upper face supported by two uprights which are inclinable and articulated between a fixed part of the frame and said upper face.

According to an additional aspect a the present invention, the first upright is situated toward the front of the vehicle, the second upright is situated toward the rear of the vehicle, the deformation of the deformable quadrilateral structure occurring in the longitudinal direction of the vehicle.

According to an additional aspect of the present invention, the two uprights are of equal length and produce a deformable parallelogram structure.

According to an additional aspect of the present invention, the first upright is shorter than the second upright in order to modify the orientation of the upper face as a function of the inclination of the uprights.

According to another aspect of the present invention, the frame also comprises actuating means for the deformable quadrilateral structure.

According to an additional aspect of the present invention, the actuating means can be controlled from inside a driver's cabin of the maintenance vehicle.

According to an additional aspect of the present invention the actuating means are controlled by the orientation of the jib.

According to another aspect of the present invention, the frame also comprises means for locking the deformation of the deformable quadrilateral structure as a function of the position of the jib.

According to an additional aspect of the present invention, the actuating means comprise at least one hydraulic cylinder.

According to another aspect of the present invention the at least one hydraulic cylinder connects the two uprights of the deformable quadrilateral structure.

According to another aspect of the present invention, the at least one hydraulic cylinder connects a fixed part of the frame and in upright of the deformable quadrilateral structure.

According to another aspect of the present invention, the deformable quadrilateral structure deforms between a first and a second predetermined height, the difference in the height of the jib between the two positions being between 20 and 40 centimeters.

The embodiments of the present invention also relate to a ski rim maintenance vehicle having a winch and comprising a frame as described above.

Other features and advantages of the invention will appear in the following description thereof, with reference to the appended drawings which represent, in indicative but non-limiting fashion, one possible embodiment thereof.

In these drawings:

FIG. 1 shows a diagram of a side view of a frame according to a first embodiment of the present invention in a first predetermined position;

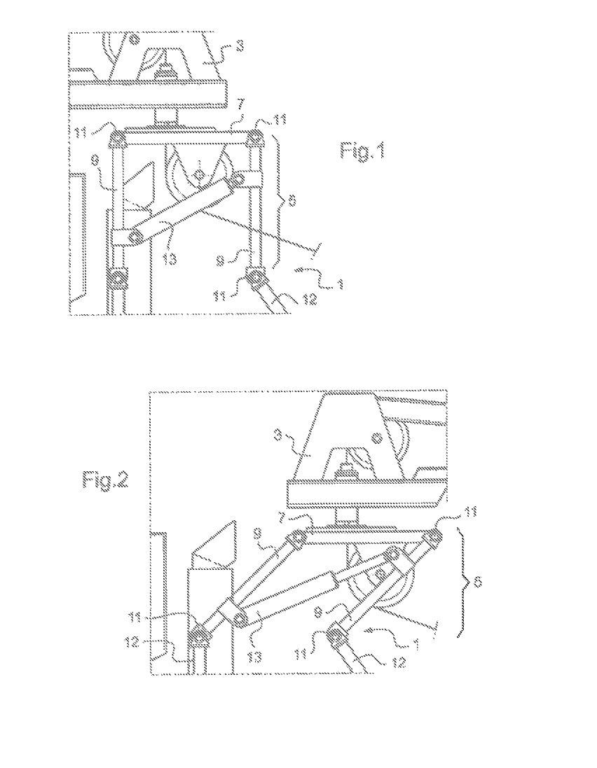

FIG. 2, shows a diagram of a side view of a frame according to a first embodiment of the present invention in a second predetermined position;

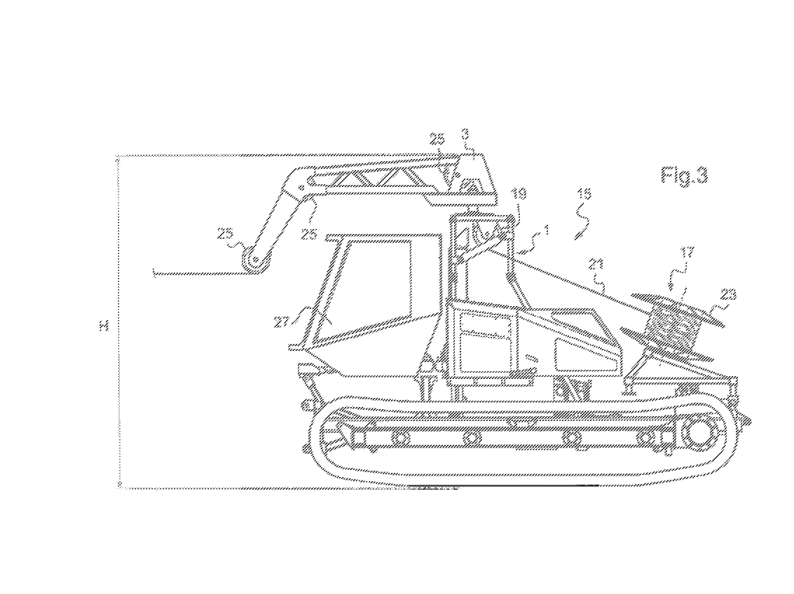

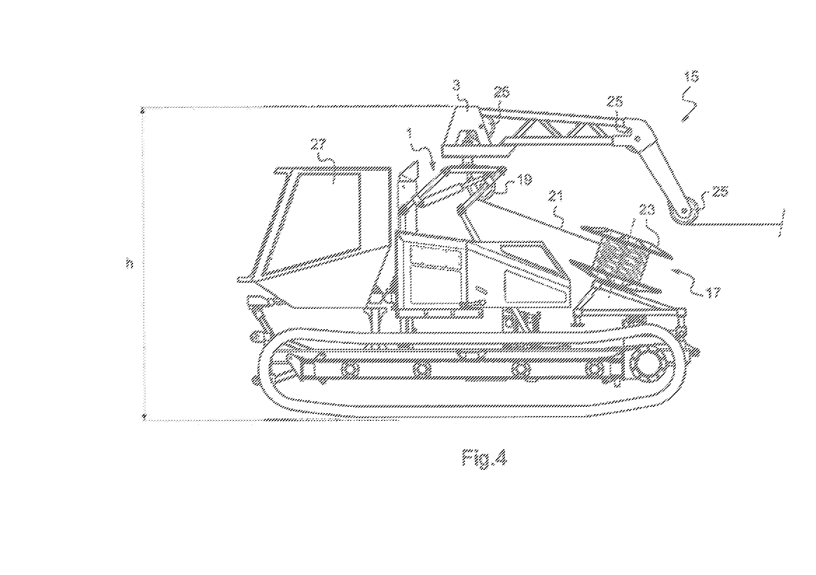

FIG. 3 shows a diagram of a side view of a ski run maintenance vehicle according to a first embodiment of the present invention in a first predetermined position;

FIG. 4 shows a diagram of a side view of a ski run maintenance vehicle according to a first embodiment of the present invention in a second predetermined position;

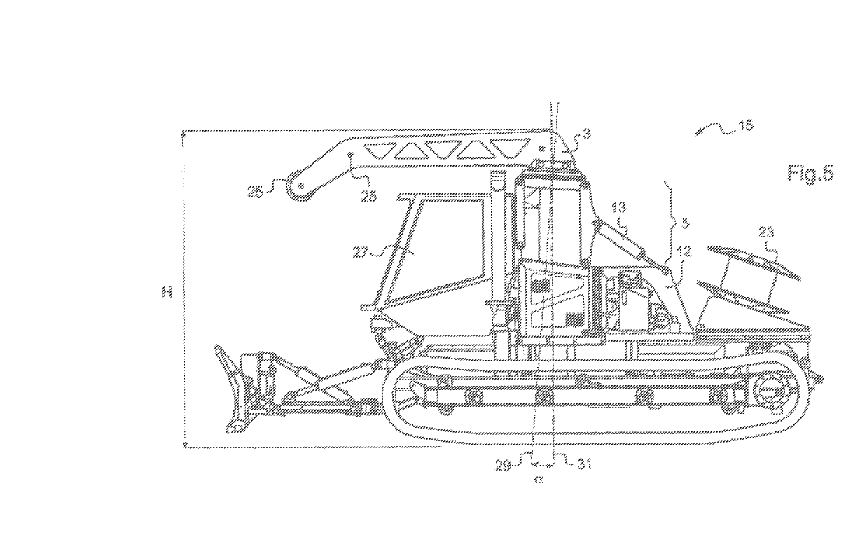

FIG. 5 shows a diagram of a side view of a ski run maintenance vehicle according to a second embodiment of the present invention in a first predetermined position;

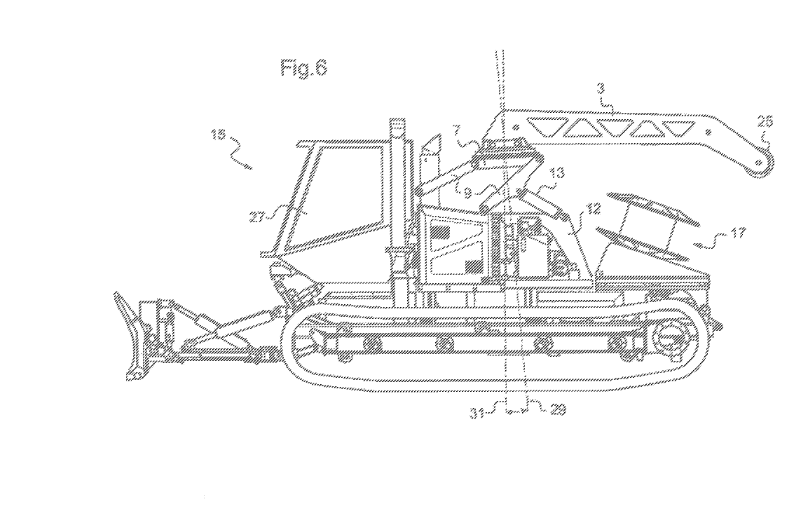

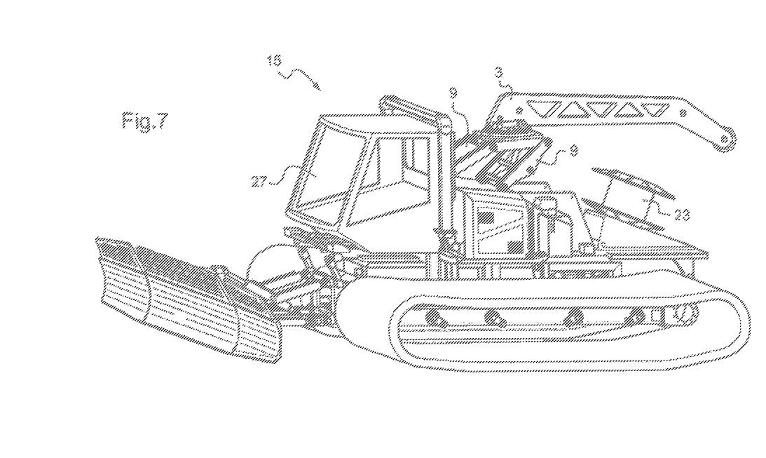

FIG. 6 shows a diagram of a side, view of a ski run maintenance vehicle according to a second embodiment of the present invention in a second predetermined position;

FIG. 7 flare shows a diagram of an isometric view of a ski run maintenance vehicle according to a second embodiment of the present invention.

In the following description, the following is designated in general terms:

The term “ski run” corresponds to any slope which has natural or artificial snow cover and which is designed to be used by skiers or users of any other means of moving about on snow.

The embodiments of the present invention relate to a frame 1 designed to support a jib 3 and comprising a deformable quadrilateral structure 5 as shown in FIG. 1. The structure 5 comprises an upper face 7 of substantially rectangular shape on which the jib 3 is positioned, said upper face 7 being borne by uprights 9.

The uprights 9 are situated on either side of said upper face 7 and support the upper face 7 by means of four pivot connections 11 arranged laterally at the four corners of said upper face 7. The uprights can be four in number, two forward uprights and two rear uprights or can be connected two by two laterally so as to form one forward upright and one rear upright.

The uprights 9 are also connected to a fixed. part 12 of the frame 1 by means of four pivot connections 11. Thus, the pivot connections 11 make it possible for two lateral quadrilaterals 5, one on each side of the upper face 7, to deform in the longitudinal direction of the vehicle and therefore make it possible for the height of the upper face 7 to be varied.

According to a first embodiment, the uprights are of equal length and produce a deformable parallelogram structure as shown in FIG. 1.

Moreover, the frame 1 comprises actuating means 13, such as fix example a hydraulic cylinder, by means of which the deformation of the deformable structure 5 can be controlled According to one embodiment, the hydraulic cylinder 13 is attached on one hand to a forward upright 9 and on the other hand to a rear upright 9 as shown in FIG. 1. According to the chosen embodiment, a single hydraulic cylinder 13 controls the deformation of the deformable structure 5 or a second cylinder 13 may also be positioned symmetrically with respect to the first cylinder on the other side of the deformable structure 5. In this latter case, the two cylinders 13 are synchronized such that they are actuated in the same manner The hydraulic, cylinder 3 is preferably positioned substantially along a diagonal of a parallelogram of the deformable structure 5. In the up position, as shown in FIG. 1. the cylinder 13 is retracted and the parallelograms are of approximately rectangular shape In the down or retracted position as shown in FIG. 2, the cylinder 13 is deployed and the parallelograms 5 are approximately lozenge-shaped.

Alternatively the hydraulic cylinder connects a fixed part 12 of the frame 1 to an upright 9 of the deformable structure 5. In the same manner as in the preceding embodiment, a second cylinder 13 may be coupled between the fixed part 12 and the upright of the deformable structure 5 on the other side of said deformable structure.

FIG. 3 shows a ski run maintenance vehicle 15 having a winch 17 equipped with a frame 1 as described above. The fixed part 12 of the frame 1 is attached to the chassis of the vehicle 15. The frame 1 comprises a pulley 19 by means of which the cable 21 can be oriented from the frame 1 toward the winding drum 23 on one hand and toward the jib 3 on the other hand, wherein the axis of rotation of the jib is hollow such that the cable can pass through. The jib 3 is connected to the upper face 7 of the frame 1 by a pivot connection allowing the jib 3 to pivot through 360°. The jib 3 comprises pulleys 25 in order to orient the cable 21 on one hand toward the pulley 19 of the frame 1 and on the other hand toward an attachment point of the cable 21. In the up position, the total height of the vehicle 15, denoted as H, is approximately 3.3 m. In the down position, as shown in FIG. 4, the total height of the vehicle 15, denoted h, is approximately 3 m. The difference in height between the up position and the down position is therefore 30 cm. Depending on the dimensions of the deformable structure 5, this difference in height is between 20 and 40 centimeters, which can be enough to pass underneath certain obstacles. Moreover, In the down position, the jib is situated lower than the driver's cabin which becomes the highest point of the vehicle.

In addition, according to a first embodiment, the actuating means 13 can be controlled from inside the driver's cabin 27 of the vehicle 15. Thus the driver of the vehicle 15 can transition from one position of the frame 1 to the other without having to leave the driver's cabin 27.

According to a second embodiment, the cylinders are controlled automatically as a function of the orientation of the jib. Thus, when the jib is oriented forwards, the cylinder retracts in order to position the jib in the up position and, when the jib is oriented backwards, the cylinder deploys in order to position the jib in the down position, jib that end, the frame also comprises angle sensors, complemented by inductive sensors which measure or detect the position of the jib 3 (orientation angle with respect to the machine axis and height position). In the event of a problem with one of the sensors, a default mode, in which the jib 3 is automatically put into the up position, is triggered. In some cases, in which it is no longer possible to know the height of the jib 3, the vehicle stops in order to avoid an accident.

Furthermore, the frame 1 also comprises a safety measure in order to allow the jib 3 to go from an up position to a down position only for certain orientations of the jib 3. For example, the hydraulic cylinder 13 can be locked in the up position when the jib 3 is oriented toward the front of the vehicle 15, such that the jib 3 can be lowered only when the jib 3 is positioned toward the rear of the vehicle 15. Indeed, depending on the configuration of the vehicle 15, the down position of the jib 3 can be lower than the height of the driver's cabin 27 or of its accessories such as a rotary beacon, such that actuation of the frame 1 toward a down position when the jib 3 is oriented toward the front of the vehicle 15 could damage part of the vehicle 15.

According to another embodiment, the upright or uprights 9 situated at the front of the deformable structure 5 are shorter than the upright or uprights situated at the back of the deformable structure 5, which causes a change in the orientation of the upper face 7 and thus of the jib 3 when the deformable structure 5 is deformed, as shown in FIGS. 5 and 6. With the exception of the difference in the length of the uprights 9, the frame 1 of FIGS. 5 and 6 has the same characteristics as the frame 1 described previously in FIGS. 1 to 4. Thus, as a function of the deformation of the structure 5, the caster angle, denoted a, between the axis of rotation of the jib 29 and the vertical 31 varies such that when the jib 3 is in the up position, shown in FIG. 5, the caster angle a is oriented toward the front of the vehicle 15 whereas When the jib 3 is in the down position, shown in FIG. 6, the caster angle a is oriented toward the rear of the vehicle 15. Changing this caster angle a makes it possible to improve the stability of the vehicle 15 when it is pulled from the front when the jib 3 is in the up position and when it is pulled from the back when the jib 3 is in the down position. Moreover, in FIGS. 5 and 6 the actuating means 13 are positioned between a rear upright 9 of the deformable structure and a fixed part 12 of the frame 1. However, as for the parallelogram embodiment, the actuating means 13 can be situated between two uprights 9 of the deformable structure 5. Equally, the actuating means 13 can be controlled manually or automatically as a function of the position of the jib such that the upper face 7 is in the up position when the jib 3 is directed toward the front of the vehicle 15 and in the down position when the jib is directed toward the rear of the vehicle 15.

FIG. 7 is an isometric view of the vehicle of FIGS. 5 and 6, which shows the two uprights 9 (forward and rear) of the deformable structure 5 and the rectangular shape of the upper surface 7.

Thus the use of a frame comprising a deformable parallelogram structure and of actuating means for the deformation of the parallelogram which can be controlled from the driver's cabin makes it possible to be able to reduce the overall height of the vehicle in order to avoid an obstacle or in order to be able to enter a garage or hangar, which makes it possible to save time while improving the safety of the users with respect to the solutions known from the prior art.

1.-14. (canceled)

15. A frame configured for mounting on a vehicle having a winch and a cable receiving structure, the cable receiving structure configured to be coupled to the frame, the winch having a winding drum and the cable receiving structure configured to receive a cable from the winding drum, the frame comprising:
a deformable quadrilateral structure operable to adjust a height of the cable receiving structure and guide the cable between the winding drum and the cable receiving structure, wherein adjusting the height of the cable receiving structure in a predetermined direction reduces an overall height of the vehicle.
